(19) United States
(12) Patent Application Publication
(10) Pub. No.: US 2003/0154101 A1
(43) Pub. Date: Aug. 14, 2003

(54) System, methods, and medium for facilitating providing a quote

(76) Inventors: Kevin Carl Archibald, Streamwood, IL (US); Gary Justin Dinmore, Mukwonago, WI (US); Thomas E. Krebsbach, Pewaukee, WI (US); Ronald Thomas DuKatz, Franklin, WI (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/683,783

(22) Filed: Feb. 13, 2002

(51) Int. Cl. G06F 17/60

(52) U.S. Cl. 705/2

(57) ABSTRACT

A network based method for facilitating providing a customer with a quote for at least one of a manufactured product and a service includes receiving data relating to at least one of a customer desired product and a customer desired service, providing the customer a budgetary quote based on the received data, receiving a customer response based on the budgetary quote, and providing the customer a contractual quote based on the received customer response.

### BACKGROUND OF INVENTION

This invention relates generally to medical systems, and more particularly, to providing quotes for the purchase of medical products and services.

When a customer requests a purchase price for a medical product or service from a manufacturer, the manufacturer typically invests a considerable expense in generating a quote. The manufacturer's sales representative manually prepares a purchase price quote thereby generating multiple paper copy versions of the quote and associated documents, as budgetary and then as contractual quotes. The sales representative then typically negotiates the quote with the customer using a phone or by visiting the customer's business to negotiate the quote. Accordingly, the customer typically waits an extended amount of time to finalize the quote and thereby purchase the requested product or service. Additionally, the customer may decide not to purchase the product or service, and the manufacturer does not recoup the resources invested in providing the quote. Furthermore, some customers will change their desired product or service features and request a second quote seeking a less expensive solution. Accordingly, the manufacturer invests additional resources to generate and provide a second quote.

### SUMMARY OF INVENTION

In one aspect, a network based method for facilitating providing a customer with a quote for at least one of a manufactured product and a service is provided. The method includes receiving data relating to at least one of a customer desired product and a customer desired service, providing the customer a budgetary quote based on the received data, receiving a customer response based on the budgetary quote, and providing the customer a contractual quote based on the received customer response.

In another aspect, a network based method for facilitating providing a customer with a quote for at least one of a medical product and a medical service is provided. The method includes receiving data relating to at least one of a customer desired medical product and a customer desired medical service, publishing a budgetary quote as an Extensible Markup Language (XML) document, loading the XML budgetary quote in a quote repository, sending an email alert to the customer, wherein the email alert includes a Uniform Resource Locator (URL) indicating a location of the published budgetary quote, and providing the customer access to view the budgetary quote via the URL. The method also includes receiving a customer response based on the budgetary quote, publishing a contractual quote as an Extensible Markup Language (XML) document, loading the XML contractual quote in a quote repository, sending an email alert to the customer, wherein the email alert includes a Uniform Resource Locator (URL) indicating a location of the published contractual quote, providing the customer access to view the budgetary quote via the URL, and receiving a customer response including at least one of a message to a manufacturer, an acceptance of the contractual quote, and a denial of the contractual quote. In a further aspect, a network based system for providing a customer with a quote for at least one of a manufactured product and a service is provided. The system includes at least one device, and a server connected to the device and configured to receive data relating to at least one of a customer desired product and a customer desired service, provide the customer a budgetary quote based on the received data, receive a customer response based on the budgetary quote, and provide the customer a contractual quote based on the received customer response. In a still further aspect, a network based system for providing a customer with a quote for at least one of a manufactured product and a service is provided. The system includes at least one device, and a server connected to the device and configured to receive data relating to at least one of a customer desired medical product and a customer desired medical service, publish a budgetary quote as an Extensible Markup Language (XML) document, load the XML budgetary quote in a quote repository, send an email alert to the customer, wherein the email alert includes a Uniform Resource Locator (URL) indicating a location of the published budgetary quote, and provide the customer access to view the budgetary quote via the URL. The server is also configured to receive a customer response based on the budgetary quote, publish a contractual quote as an Extensible Markup Language (XML) document, load the XML contractual quote in a quote repository, send an email alert to the customer, wherein the email alert includes a Uniform Resource Locator (URL) indicating a location of the published contractual quote, and provide the customer access to view the budgetary quote via the URL, and receive a customer response comprising at least one of a message to a manufacturer, an acceptance of the contractual quote, and a denial of the contractual quote.

In yet another aspect, a computer readable medium encoded with a program executable by a computer for providing a customer with a quote for at least one of a manufactured product and a service is provide. The program is configured to instruct the computer to receive data relating to at least one of a customer desired product and a customer desired service, provide the customer a budgetary quote based on the received data, receive a customer response based on the budgetary quote, and provide the customer a contractual quote based on the received customer response. In yet another further aspect, a computer readable medium encoded with a program executable by a computer for providing a customer with a quote for at least one of a manufactured product and a service is provided. The program is configured to instruct the computer to receive data relating to at least one of a customer desired medical product and a customer desired medical service, publish a budgetary quote as an Extensible Markup Language (XML) document, load the XML budgetary quote in a quote repository, send an email alert to the customer, wherein the email alert includes a Uniform Resource Locator (URL) indicating a location of the published budgetary quote, and provide the customer access to view the budgetary quote via the URL. The program is also configured to instruct the computer to receive a customer response based on the budgetary quote, publish a contractual quote as an Extensible Markup Language (XML) document, load the XML contractual quote in a quote repository, send an email alert to the customer, wherein the email alert includes a Uniform Resource Locator (URL) indicating a location of the published contractual quote, and provide the customer access to view the budgetary quote via the URL, and receive a customer response comprising at least one of a message to a manufacturer, an acceptance of the contractual quote, and a denial of the contractual quote.

### BRIEF DESCRIPTION OF DRAWINGS

FIG. 1 is a block diagram of web-based integrated customer request for quote (RFQ) response system in accordance with one embodiment of the present invention.

FIG. 2 is an expanded block diagram of an exemplary embodiment of a server architecture of a RFQ response system.

FIG. 3 is a flow chart for facilitating providing a customer with a quote.

### DETAILED DESCRIPTION

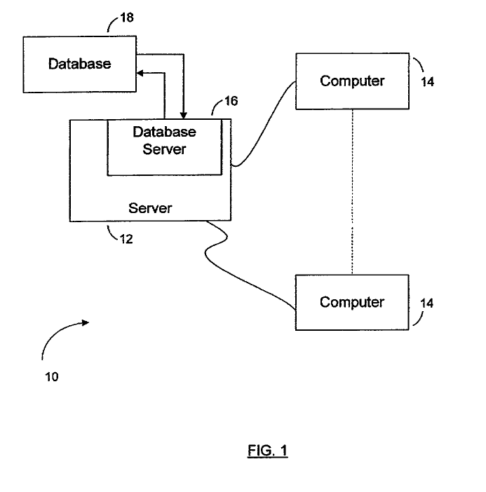

FIG. 1 is a block diagram of a web-based integrated customer request for quote (RFQ) response system 10 in accordance with one embodiment of the present invention. System 10 includes a server sub-system 12, sometimes referred to herein as a server and a web server, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including cable modems, high-speed Integrated Services Digital Network (ISDN) lines, and telephone connections including telephone modems and DSL connections (Digital Subscriber Line). Alternatively, devices 14 are any device capable of interconnecting to a network including a network-based phone or other network-based connectable equipment including a hand-held wireless device. Server 12 includes a database server 16 connected to a centralized database 18 including a computer readable medium containing inventory information, image files, and component information. In one embodiment, centralized database 18 is stored on database server 16 and can be accessed by potential users at one of user devices 14 by logging onto server subsystem 12 through one of user devices 14. In an alternative embodiment, centralized database 18 is stored remotely from server 12. In a further embodiment, a plurality of databases 18 are stored remotely from server 12, such as, for example an inventory control database, a component database, and an image database.

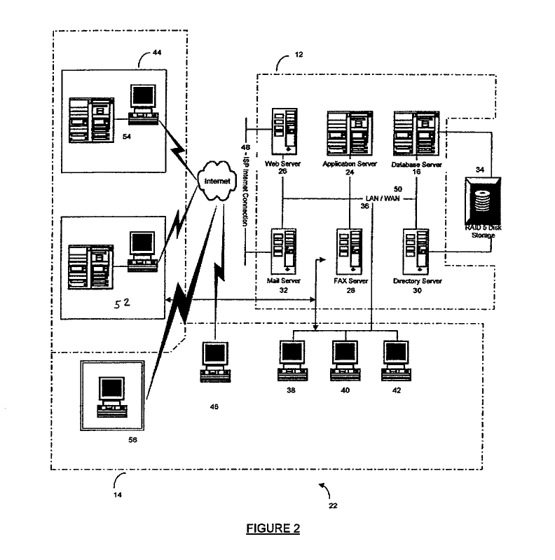

FIG. 2 is an expanded block diagram of an exemplary embodiment of a server architecture of a RFQ response system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In an alternative embodiment, server sub-system 12 is configured to be communicatively coupled to various individuals or employees 44 and to third parties, e.g., users, 46 via an Internet Service Provider (ISP) Internet connection 48. The communication in the exemplary embodiment is illustrated as being performed via the Internet, however, any other WAN type communication can be utilized in other embodiments, i.e., the systems and processes are not limited to being practiced via the Internet. In addition, and rather than a WAN 50, local area network 36 could be used in place of WAN 50.

In an exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

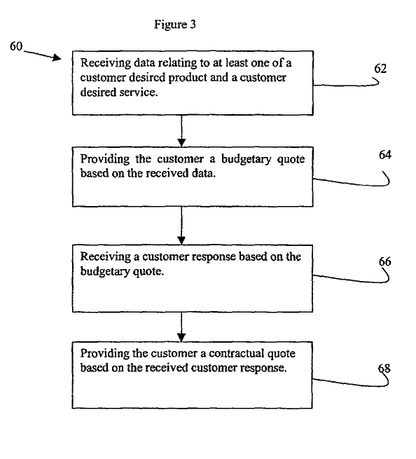

FIG. 3 is a network based method 60 for facilitating providing a customer with a quote for at least one of a manufactured product and/or a service. Method 60 includes receiving 62 data relating to at least one of a customer desired product and/or a customer desired service, providing 64 the customer a budgetary quote based on the received data, receiving 66 a customer response based on the budgetary quote, and providing 68 the customer a contractual quote based on the received customer response.

In use a customer utilizes device 14 to access the manufacturer's website and is prompted to enter desired features and functions for a desired manufactured product and/or service. In one embodiment, the customer is prompted to select a desired language from a plurality of languages, such as but not limited to, Spanish, Italian, German, French, and English. Selecting a desired language enables the customer to negotiate the budgetary quote and the contractual quote in the customer's preferred language. A web server 26 (shown in FIG. 1) receives the customer's data for desired product and/or service. In one embodiment the desired product is a medical product, and the desired service is a medical service, such as, but not limited to, training, product installation, and software installation. In an exemplary embodiment, the customer utilizes a template including a plurality of blank data fields. The customer enters data in the blank fields and selects a submit button to transmit the data to server 12. A manufacturer sales representative receives the data relating to at least one of the customer desired product and/or the customer desired service and creates a budgetary quote. In one embodiment, the sales representative publishes the budgetary quote as an Extensible Markup Language (XML) document. The XML budgetary quote is loaded into a quote repository and an email alert is sent to the customer. The email alert includes at least one address to provide the customer access to view the budgetary quote on a manufacturer server, such as but not limited to server 12 (shown in FIG. 1). In one embodiment, the email alert includes a Uniform Resource Locator (URL), i.e. a specific website address indicating a location of the published budgetary quote. Alternatively, the customer may view the quote by logging on to the manufacturer's website and selecting an option listed on the manufacturer's website.

In one embodiment, the customer can add a note to the budgetary quote as a message to the sales representative. The sales representative then receives the note and may adjust the budgetary quote and then republish the budgetary quote. The customer then receives another email alert notifying the customer that the quote has been republished. In another embodiment, the sales representative receives the note and may adjust the budgetary quote and then email the adjusted budgetary quote to the customer.

Additionally, as the customer's project moves forward from a budget stage toward an implementation stage, the customer can request a contractual quote. As used herein, a budgetary quote means a non-binding, good faith quote, to assist the customer in developing a budget for a project, and a contractual quote means a binding quote. Once the customer has requested a contractual quote, the sales representative publishes the contractual quote as an Extensible Markup Language (XML) document. The XML contractual quote is loaded into a quote repository and an email alert is sent to the customer. The email alert includes at least address to provide the customer access to view the contractual quote on a manufacturer server, such as but not limited to server 12 (shown in FIG. 1). In one embodiment, the email alert includes a URL. Alternatively, the customer may view the contractual quote by logging on to the manufacturer's website and selecting an option listed on the manufacturer's website.

In one embodiment, the customer can add a note to the contractual quote as a message to the sales representative. The sales representative then receives the note and may adjust and republish the contractual quote. The customer then receives another email alert notifying the customer that the quote has been republished. In another embodiment, the customer can either accept or decline the contractual quote.

While the invention has been described in terms of various specific embodiments, those skilled in the art will recognize that the invention can be practiced with modification within the spirit and scope of the claims.

1. A network based method for facilitating providing a customer with a quote for at least one of a manufactured product and a service, said method comprising:
receiving data relating to at least one of a customer desired product and a customer desired service;
providing the customer a budgetary quote based on the received data;
receiving a customer response based on the budgetary quote; and
providing the customer a contractual quote based on the received customer response.

2. A network based method in accordance with claim 1 wherein receiving data relating to at least one of a customer desired product and a customer desired service comprises receiving data relating to at least one of a customer desired medical product and a customer desired medical service.

3. A network based method in accordance with claim 1 further comprising prompting the customer to select a desired language from a plurality of languages.

4. A network based method in accordance with claim 1 wherein providing the customer a budgetary quote based on the received data comprises:
publishing the budgetary quote as an Extensible Markup Language (XML) document;
loading the XML budgetary quote in a quote repository; and
sending an email alert to the customer, wherein said email alert comprises a Uniform Resource Locator (URL) indicating a location of the published budgetary quote.

5. A network based method in accordance with claim 4 wherein providing the customer a budgetary quote based on the received data further comprises:
providing the customer access to view the budgetary quote via the URL; and
receiving a customer response comprising at least one of a message to the manufacturer and a request for a contractual quote.

6. A network based method in accordance with claim 1 wherein providing the customer a contractual quote based on the received data comprises:
publishing the contractual quote as an Extensible Markup Language (XML) document;
loading the XML contractual quote in a quote repository; and
sending an email alert to the customer, wherein said email alert comprises a Uniform Resource Locator (URL) indicating a location of the published contractual quote.

7. A network based method in accordance with claim 6 wherein providing the customer a contractual quote based on the received data further comprises:
providing the customer access to view the budgetary quote via the URL; and
receiving a customer response comprising at least one of a message to a manufacturer, an acceptance of the contractual quote, and a denial of the contractual quote.

8. A network based method for facilitating providing a customer with a quote for at least one of a medical product and a medical service, said method comprising:
receiving data relating to at least one of a customer desired medical product and a customer desired medical service;
publishing a budgetary quote as an Extensible Markup Language (XML) document;
loading the XML budgetary quote in a quote repository;
sending an email alert to the customer, wherein said email alert comprises a Uniform Resource Locator (URL) indicating a location of the published budgetary quote;
providing the customer access to view the budgetary quote via the URL;
receiving a customer response based on the budgetary quote;
publishing a contractual quote as an Extensible Markup Language (XML) document;
loading the XML contractual quote in a quote repository;
sending an email alert to the customer, wherein said email alert comprises a Uniform Resource Locator (URL) indicating a location of the published contractual quote;
providing the customer access to view the budgetary quote via the URL; and
receiving a customer response comprising at least one of a message to a manufacturer, an acceptance of the contractual quote, and a denial of the contractual quote.

9. A network based system for providing a customer with a quote for at least one of a manufactured product and a service, said system comprising:
at least one device; and
a server connected to said device and configured to:
receive data relating to at least one of a customer desired product and a customer desired service;
provide the customer a budgetary quote based on the received data;
receive a customer response based on the budgetary quote; and
provide the customer a contractual quote based on the received customer response.

10. A network based system in accordance with claim 9 wherein to receive data relating to at least one of a customer desired product and a customer desired service, said server further configured to receive data relating to at least one of a customer desired medical product and a customer desired medical service.

11. A network based system in accordance with claim 9 wherein said server further configured to prompt a customer to select a desired language from a plurality of languages.

12. A network based system in accordance with claim 9 wherein to provide the customer a budgetary quote based on the received data, said server further configured to:
publish the budgetary quote as an Extensible Markup Language (XML) document;
load the XML budgetary quote in a quote repository; and
send an email alert to the customer, wherein said email alert comprises a Uniform Resource Locator (URL) indicating a location of the published budgetary quote.

13. A network based system in accordance with claim 12 wherein to provide the customer a budgetary quote based on the received data, said server further configured to:
providing the customer access to view the budgetary quote via the URL; and
receive a customer response comprising at least one of a message to the manufacturer and a request for a contractual quote.

14. A network based system in accordance with claim 9 wherein to provide the customer a contractual quote based on the received data, said server further configured to:
publish the contractual quote as an Extensible Markup Language (XML) document;
load the XML contractual quote in a quote repository; and
send an email alert to the customer, wherein said email alert comprises a Uniform Resource Locator (URL) indicating a location of the published contractual quote.

15. A network based system in accordance with claim 14 wherein to provide the customer a contractual quote based on the received data, said server further configured to:
provide the customer access to view the budgetary quote via the URL; and
receive a customer response comprising at least one of a message to a manufacturer, an acceptance of the contractual quote, and a denial of the contractual quote.

16. A network based system for providing a customer with a quote for at least one of a manufactured product and a service, said system comprising:
at least one device; and
a server connected to said device and configured to:
receive data relating to at least one of a customer desired medical product and a customer desired medical service;
publish a budgetary quote as an Extensible Markup Language (XML) document;
load the XML budgetary quote in a quote repository;
send an email alert to the customer, wherein said email alert comprises a Uniform Resource Locator (URL) indicating a location of the published budgetary quote;
provide the customer access to view the budgetary quote via the URL;
receive a customer response based on the budgetary quote;
publish a contractual quote as an Extensible Markup Language (XML) document;
load the XML contractual quote in a quote repository;
send an email alert to the customer, wherein said email alert comprises a Uniform Resource Locator (URL) indicating a location of the published contractual quote;
provide the customer access to view the budgetary quote via the URL; and
receive a customer response comprising at least one of a message to a manufacturer, an acceptance of the contractual quote, and a denial of the contractual quote.

17. A computer readable medium encoded with a program executable by a computer for providing a customer with a quote for at least one of a manufactured product and a service, said program configured to instruct the computer to:
receive data relating to at least one of a customer desired product and a customer desired service;
provide the customer a budgetary quote based on the received data;
receive a customer response based on the budgetary quote; and
provide the customer a contractual quote based on the received customer response.

18. A computer readable medium in accordance with claim 17 wherein to receive data relating to at least one of a customer desired product and a customer desired service, said medium further configured to receive data relating to at least one of a customer desired medical product and a customer desired medical service.

19. A computer readable medium in accordance with claim 17 wherein said medium further configured to prompt a customer to select a desired language from a plurality of languages.

20. A computer readable medium in accordance with claim 17 wherein to provide the customer a budgetary quote based on the received data, said medium further configured to:
publish the budgetary quote as an Extensible Markup Language (XML) document;
load the XML budgetary quote in a quote repository; and
send an email alert to the customer, wherein said email alert comprises a Uniform Resource Locator (URL) indicating a location of the published budgetary quote.

21. A computer readable medium in accordance with claim 17 wherein to provide the customer a budgetary quote based on the received data, said medium further configured to:
provide the customer access to view the budgetary quote via the URL; and
receive a customer response comprising at least one of a message to the manufacturer and a request for a contractual quote.

22. A computer readable medium in accordance with claim 17 wherein to provide the customer a contractual quote based on the received data, said medium further configured to:
publish the contractual quote as an Extensible Markup Language (XML) document;
load the XML contractual quote in a quote repository; and
send an email alert to the customer, wherein said email alert comprises a Uniform Resource Locator (URL) indicating a location of the published contractual quote.

23. A computer readable medium in accordance with claim 22 wherein to provide the customer a contractual quote based on the received data, said medium further configured to:
provide the customer access to view the budgetary quote via the URL; and
receive a customer response comprising at least one of a message to a manufacturer, an acceptance of the contractual quote, and a denial of the contractual quote.

24. A computer readable medium encoded with a program executable by a computer for providing a customer with a quote for at least one of a manufactured product and a service, said program configured to instruct the computer to:
receive data relating to at least one of a customer desired medical product and a customer desired medical service;
publish a budgetary quote as an Extensible Markup Language (XML) document; load the XML budgetary quote in a quote repository;
send an email alert to the customer, wherein said email alert comprises a Uniform Resource Locator (URL) indicating a location of the published budgetary quote;
provide the customer access to view the budgetary quote via the URL; and
receive a customer response based on the budgetary quote;
publish a contractual quote as an Extensible Markup Language (XML) document;
load the XML contractual quote in a quote repository;
send an email alert to the customer, wherein said email alert comprises a Uniform Resource Locator (URL) indicating a location of the published contractual quote;
provide the customer access to view the budgetary quote via the URL; and
receive a customer response comprising at least one of a message to a manufacturer, an acceptance of the contractual quote, and a denial of the contractual quote.
